(19) United States
(12) Patent Application Publication
(10) Pub. No.: US 2023/0309750 A1
(43) Pub. Date: Oct. 5, 2023

(54) REMOVABLE TIERED BASKET

(71) Applicant: CFA Properties, Inc., Atlanta, GA (US)

(72) Inventor: William Brandon Goodwin, Decatur, GA (US)

(21) Appl. No.: 18/193,255

(22) Filed: Mar. 30, 2023

Related U.S. Application Data
(60) Provisional application No. 63/326,024, filed on Mar. 31, 2022.

(51) Int. Cl. A47J 37/12

(52) U.S. Cl. CPC A47J 37/1295

(57) ABSTRACT

Embodiments of the present disclosure provide for a removeable tiered baskets having shelves that can be removed without tools. In some embodiments, the basket may comprise a frame having opposing first side wall and second side wall defining a space therebetween. The first side wall may define a first set of coupling slots and the second side wall may define a second set of coupling slots. The basket may comprise a plurality of shelves. The plurality of shelves may be vertically stackable between the first side wall and the second side wall, and may be pivotable between a substantially horizontal position and a substantially vertical position. Each shelf of the plurality of shelves may comprise coupling members extending through corresponding slots of the first set of coupling slots and the second set of coupling slots to provide for removing each shelf from within the frame without tools.

### CROSS REFERENCE TO RELATED APPLICATIONS

The application claims priority to and the benefit of U.S. Provisional Application No. 63/326,024, titled “REMOVABLE TIERED BASKET,” filed Mar. 31, 2022, the contents of which is incorporated by reference herein in its entirety.

### TECHNOLOGICAL FIELD

Example embodiments of the present invention relate generally to food service systems and, more particularly, to removable tiers/shelves for baskets.

### BACKGROUND

The food service industry—particularly fast food restaurants—rely heavily on cooking baskets for frying various food items (e.g., chicken, fish, etc.). These baskets are typically submerged in hot cooking oil to fry food items and employees are generally required to lift and move them around, thus these baskets are usually designed to be light weight. However, because of the severe heating cycles that these baskets are put through, mishandling (e.g., dropping on the floor), and various other reasons, these baskets— particularly the tines of the tiers or shelves—tend to break or otherwise come apart quite easily and frequently. Moreover, when these baskets break/come apart, the entire basket generally has to be replaced. Accordingly, a need exists for removable tiered baskets that permit easy replacement of the tiers.

### SUMMARY

Various embodiments described herein relate to a removable tiered basket. In accordance with an aspect of the disclosure, a basket for holding food products in a cooking apparatus is provided. In one example embodiment, the basket comprises: a frame comprising opposing first side wall and second side wall defining a space therebetween, the first side wall defining a first set of coupling slots and the second side wall defining a second set of coupling slots; and a plurality of shelves, the plurality of shelves vertically stackable between the first side wall and the second side wall, and pivotable between a substantially horizontal position and a substantially vertical position. In some embodiments, each shelf of the plurality of shelves comprises coupling members extending through corresponding slots of the first set of coupling slots and the second set of coupling slots to provide for removing each shelf from within the frame without tools.

In some embodiments of the example basket, the coupling members, the first set of coupling slots, and the second set of coupling slots are further configured to enable the plurality of shelves to pivot between the substantially horizontal position and the substantially vertical position.

In some embodiments of the example basket, the plurality of shelves are configured for being pivoted from the substantially horizontal position to the substantially vertical position in top to bottom sequential order.

In some embodiments of the example basket, the frame further comprises a bottom wall and a rear wall. In some embodiments, each of the bottom wall and the rear wall is attached to the first side wall and the second side wall.

In some embodiments of the example basket, the rear wall defines a rear hook configured for coupling the basket to a support structure.

In some embodiments of the example basket, the first set of coupling slots and the second set of coupling slots are horizontally aligned to provide for positioning the plurality of shelves in the substantially horizontal position.

In some embodiments of the example basket, one or more of the first set of coupling slots and the second set of coupling slots has a length configured to provide for moving a respective shelf forward when being pivoted from the substantially horizontal position to the substantially vertical position to allow the respective shelf to clear other shelves already being pivoted to their substantially vertical position.

In some embodiments of the example basket, the plurality of shelves comprise at least one lower shelf and a top shelf.

In some embodiments of the example basket, each of the plurality of shelves comprise opposing front rod member and rear rod member; opposing first side rod member and second side rod member; and a plurality of individual longitudinal members. In some embodiments, the plurality of individual longitudinal members are spaced apart and attached to the front rod member and the rear rod member.

In some embodiments of the example basket, each of the plurality of shelves comprise opposing front rod member and rear rod member; opposing first side rod member and second side rod member; and a continuous rod member formed into a plurality of spaced apart longitudinal members and transverse end members therebetween the longitudinal members. In some embodiments, the transverse end members are attached to the front rod member and the rear rod member.

In some embodiments of the example basket, each of the opposing first side rod member and second side rod member of the at least one lower shelf comprises an indented portion configured to provide for moving the at least one lower shelf laterally within the frame when in a substantially vertical position and enable removal of the at least one lower shelf without tools.

In some embodiments of the example basket, the coupling members of the top shelf comprises a first coupling loop extending from a first end of the first side rod member and a second coupling loop extending from a second end of the second end of the second side rod member. In some embodiments, the first coupling and the second coupling loop are configured for receiving a skewer member therethrough.

In some embodiments of the example basket, the basket further comprises a locking bracket mounted on at least one of the first side wall or the second side wall. In some embodiments, the locking bracket defines a locking slot and is configured for receiving the skewer member therethrough to provide for securing the top shelf within the frame of the basket.

In some embodiments of the example basket, the frame is formed from thermally tolerant material.

In some embodiments of the example basket, the first set of coupling slots are vertically separated from each other, and the second set of coupling slots are vertically separated from each other.

In some embodiments of the example basket, one or more of the first set of coupling slots and the second set of coupling slots comprise a depressed portion configured to receive at least a portion of the corresponding shelf when in the substantially vertical position.

In accordance with another aspect of the disclosure, a replaceable shelf for a basket is provided. In one example embodiment, the shelf comprises: opposing front rod member and rear rod member; opposing first side rod member and second side rod member; and a continuous rod member formed into a plurality of spaced apart longitudinal members and transverse end members therebetween the longitudinal members. In some embodiments, the transverse end members are attached to the front rod member and the rear rod member.

In accordance with yet another aspect of the disclosure, a method for replacing a lower shelf of a basket comprising a plurality of shelves is provided. In one example embodiment, the method comprises: pivoting the lower shelf to a substantially vertical position; moving the lower shelf laterally to disengage the coupling members of the lower shelf from the frame of the basket; and separating the lower shelf from the frame of the basket.

In some embodiments of the example method, the plurality of shelves of the basket are configured for being removed sequentially from top to bottom and begins with removing a skewer member securing a top shelf of the basket to the frame of the basket.

In some embodiments of the example method, each shelf above the lower shelf must be removed before the lower shelf can be removed.

### BRIEF DESCRIPTION OF THE SEVERAL VIEWS OF THE DRAWINGS

Having thus described the various embodiments of the invention in general terms, reference will now be made to the accompanying drawings, which are not necessarily drawn to scale, and wherein:

FIG. 1 is a front/top perspective view of a tiered basket with its shelves in a horizontal position in accordance with an example embodiment of the present invention;

FIG. 2 is a front/top perspective view of a tiered basket with its shelves in a vertical position in accordance with an example embodiment of the present invention;

FIG. 3A is a front/top perspective view of a frame of a tiered basket in accordance with an example embodiment of the present invention without the shelves in place;

FIG. 3B is front/top perspective view of a portion of a tiered basket in accordance with an example embodiment of the present invention;

FIG. 3C is perspective view of a portion of a shelf of a tiered basket in accordance with an example embodiment of the present invention;

FIG. 4 is a rear/top perspective view of a frame of a tiered basket in accordance with an example embodiment of the present invention without the shelves in place;

FIG. 5 is a perspective view of a lower shelf of a tiered basket in accordance with an example embodiment of the present invention;

FIG. 6 is an elevated view of a lower shelf of a tiered basket in accordance with an example embodiment of the present invention;

FIGS. 7A-E are enlarged views of a side of a tiered basket in accordance with an example embodiment of the present invention;

FIGS. 8A-C are top perspective views of a tiered basket shelf replacement scheme in accordance with an example embodiment of the present invention;

FIG. 9 is a perspective view of a top shelf of a tiered basket in accordance with an example embodiment of the present invention;

FIG. 10 is a perspective view of the bottom of a top shelf of a tiered basket in accordance with an example embodiment of the present invention;

FIGS. 11A-B are perspective views of a skewer member in accordance with an example embodiment of the present invention;

FIG. 12 is a front view of a side wall of the tiered basket in accordance with an example embodiment of the present invention;

FIG. 13 is an interior view of a side wall of a tiered basket in accordance with an example embodiment of the present invention; and

FIGS. 14A-C are front views of a side wall of a tiered basket in accordance with an example embodiment of the present invention.

### DETAILED DESCRIPTION

Various embodiments of the present invention now will be described more fully hereinafter with reference to the accompanying drawings, in which some, but not all embodiments are shown. Indeed, the invention may be embodied in many different forms and should not be construed as limited to the various embodiments set forth herein; rather, the embodiments described herein are provided so that this disclosure will satisfy applicable legal requirements. Like numbers refer to like elements throughout.

The terms “illustrative” and “exemplary” are used to be examples with no indication of quality level. As used herein, the terms “approximately,” “generally,” and “substantially” refer to within manufacturing and/or engineering design tolerances for the corresponding materials and/or elements as would be understood by the person of ordinary skill in the art, unless otherwise indicated.

As used herein, reference is made to a tiered basket for use in conjunction with preparation of one or more food items. The present disclosure, however, contemplates that the tiered basket of the present invention may be equally applicable to other applications.

Additionally, reference herein may be made to a “cooking medium,” such as cooking oil, in which one or more food items may be submerged in order to sufficiently cook (e.g. fry) a food item for customer consumption. The present disclosure, however, contemplates that the tiered basket may also be used with any other cooking medium (e.g., water, microwaves, air, etc.) and/or used in various embodiments without a cooking medium. Furthermore, reference herein may be made to use of the tiered basket in conjunction with a “cooking operation.” The present disclosure, however, contemplates that the tiered cooking basket may be equally applicable to other applications such as holding cooked items prior to use (either with or without supplemental heat provided) and thawing.

According to one or more embodiments, the tiered basket generally comprises a basket frame and a plurality of tiers or shelves. Furthermore, one or more of the plurality of shelves is configured for supporting or otherwise holding food items (e.g., chicken fillet). For example, one or more of the plurality of shelves is configured for supporting or otherwise holding food items in a cooking medium (e.g., reservoir of cooking oil) during a cooking operation (e.g., frying). During a cooking operation, at least a portion of the tiered basket may be submerged in the cooking medium so as to perform a cooking operation.

One or more of the plurality of shelves may be pivotally secured to the frame or otherwise attached to the frame in a manner that permits selective rotation of the one or more pivotally secured shelves, such that the shelves may be pivoted from a substantially horizontal position (e.g., cooking position) to a substantially vertical position (e.g., food items loading position) and vice versa.

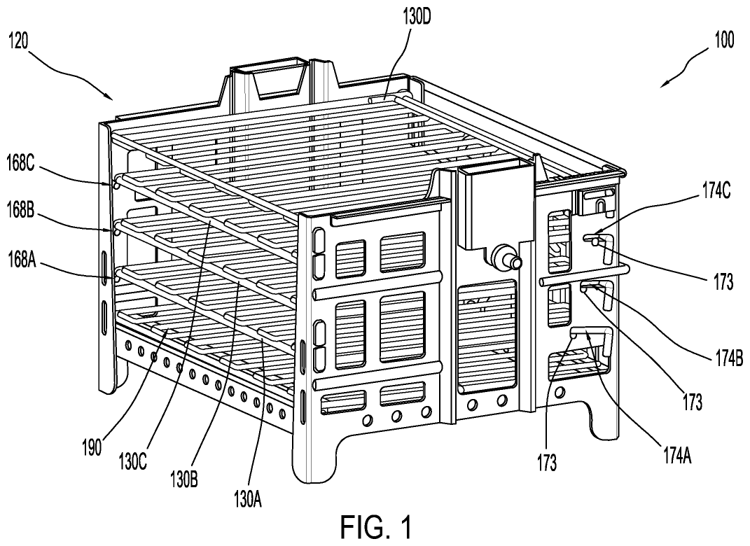

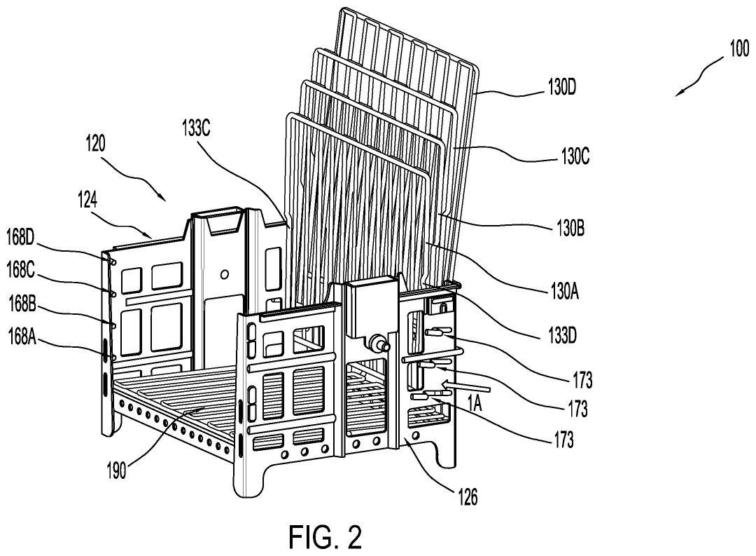

Referring to FIGS. 1-4, the tiered basket 100 includes a basket frame 120, lower shelves 130A-C, and top shelf 130D. The lower shelves 130A-C and top shelf 130D are configured to be positioned within the basket frame 120. As shown in FIG. 1, which depicts the shelves of the tiered basket 100 in a substantially horizontal position (e.g. cooking position), the lower shelves 130A-C and top shelf 130D are substantially horizontal and spaced apart to allow food items to be positioned on each of the lower shelves 130A-C such that the food items are supported on a shelf (e.g., 130A-C) with the shelf directly above preventing the food item (e.g., chicken fillet) from curling. Accordingly, in one or more embodiments, the top shelf 130D may function at least in part to prevent food items supported by the uppermost lower shelf from curling, and may or may not support food items of its own. In one or more embodiments, each of the lower shelves 130A-C and top shelf 130D may be pivoted from a substantially horizontal position (e.g., cooking position) to a substantially vertical position (e.g., loading position) as shown in FIG. 2.

A. Basket frame 120

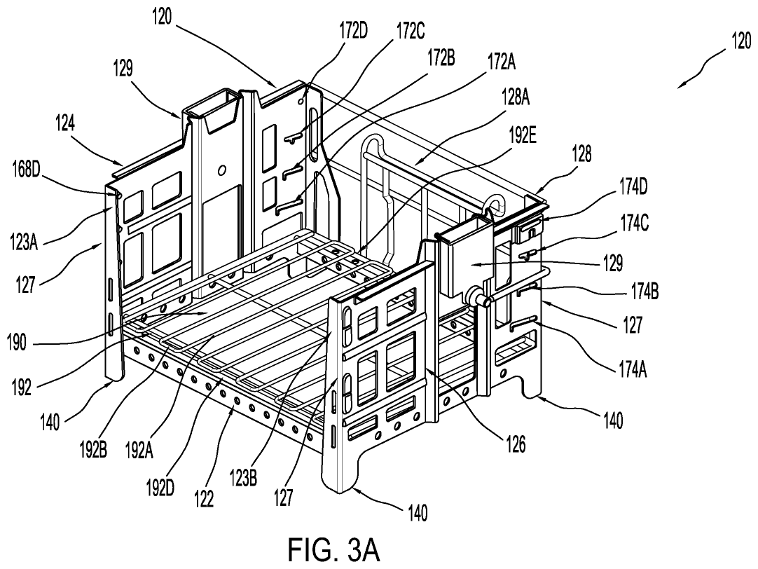

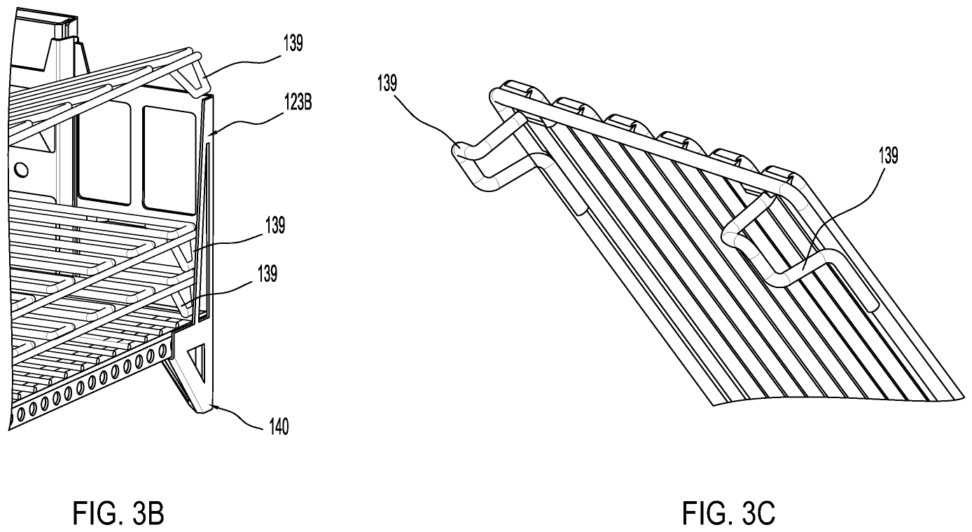

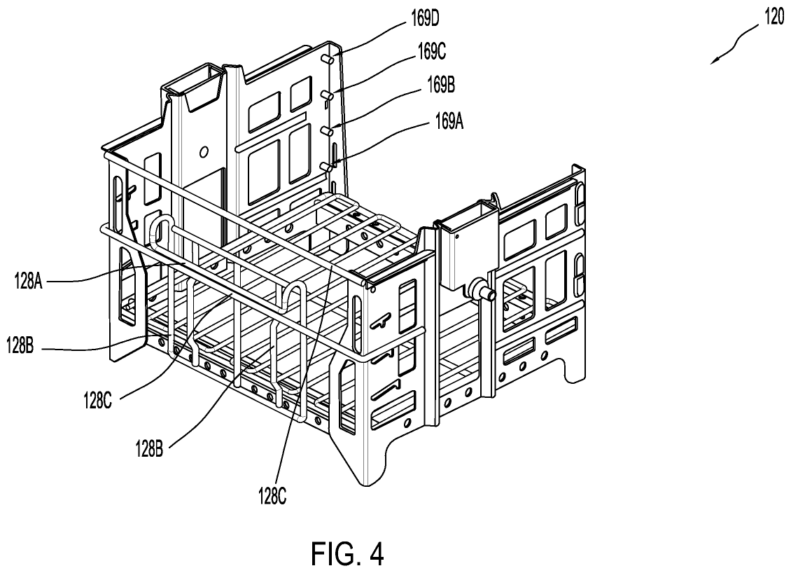

The basket frame 120 is configured for supporting or otherwise holding the lower shelves 130A-C and the top shelf 130D. In one or more embodiments, the basket frame 120 may be formed from or otherwise comprise wire frame, sheet metal, metal mesh, the like, or combinations thereof. Furthermore, in some embodiments, the basket frame 120 may be formed using one or more of a variety of techniques (e.g., laser cutting, embossing, stamping, 3D printing, computer numerical control (CNC) machining, casting, the like, or combinations thereof). As shown in FIGS. 3-4, the basket frame 120 includes a first side wall 124, a second side wall 126, and a rear wall 128, that are each attached to a bottom wall 122 and extends upwardly beyond the bottom wall 122. The first side wall 124, second side wall 126, and rear wall 128 of the basket frame 120 may be formed from thermally tolerant material. In some embodiments, the basket frame 120 may be formed from cast iron, nickel-plated carbon steel, and/or other suitable materials. In some embodiments, the basket frame 120 may be formed from a corrosion resistant food grade material (e.g., stainless steel, aluminum, titanium, or the like).

The rear wall 128 may include one or more vertical rods 128B joined to one or more horizontal rods 128C. In some embodiments, as shown in FIGS. 3-4, the rear wall 128 may define or otherwise include a rear hook 128A. For example, as shown in FIG. 4, the rear hook 128A may extend from one or more of the vertical rods 128B. In one or embodiments, the rear hook 128A may be configured for hanging the tiered basket 100 on a support structure associated with a cooking medium (e.g., reservoir of cooking oil) to suspend the tiered basket 100 above the cooking medium. For example, the rear hook 128A may be hung on a support structure having a reservoir of cooking oil such that the tiered basket 100 is positioned above the cooking oil to allow excess cooking oil to drain from the food items supported by the tiered basket 100.

In one or more embodiments, a bottom shelf 190 may be attached to the bottom wall 122. In one or more embodiments, the bottom shelf 190 may be formed from or otherwise comprise wire frame, sheet metal, metal mesh, the like, or combinations thereof. In some embodiments, the bottom shelf 190 may be formed using one or more of a variety of techniques (e.g., laser cutting, embossing, stamping, 3D printing, computer numerical control (CNC) machining, casting, the like, or combinations thereof). As shown in FIG. 3A, the bottom shelf 190 may include a bottom shelf frame 192 and a continuous wire/rod member formed into a plurality of spaced apart longitudinal members 192A and a plurality of transverse end members 192B therebetween attached to opposing end 192D and end 192E of the bottom shelf frame 192 via each of the plurality of transverse end members 192B. As shown in FIG. 3A, each of the plurality of spaced apart longitudinal members 192A extend from the opposing ends 192D, 192E to form a grill-like structure that is sufficiently dense to hold food items, such as chicken fillets, thereon. Other food items may also or alternatively be held on the shelves, including chicken strips, sausage, bacon, taco shells, etc. As will be further discussed below in relation to the lower shelves 130A-C, the above-configuration is advantageous over individually attached discrete longitudinal rods.

In one or more embodiments, the bottom shelf frame 192 and/or the continuous wire/rod member of the bottom shelf 190 may be formed from a thermal tolerant material. In some embodiments, the bottom shelf frame 192 and/or the continuous wire/rod member of the bottom shelf 190 may be formed from cast iron, nickel-plated carbon steel, and/or other suitable materials. In some embodiments, the bottom shelf frame 192 and/or the continuous wire/rod member may be formed from a corrosion resistant food grade material (e.g., stainless steel, aluminum, titanium, or the like).

In one or more embodiments, the bottom wall 122 may be attached to the first side wall 124 and the second side wall 126 using an interlocking mechanism (e.g., rigid interlocking mechanism), and/or other suitable attachment mechanisms.

The bottom wall 122, first side wall 124, second side wall 126, and rear wall 128 collectively define a top and front opening for positioning the lower shelves 130A-C and top shelf 130D therein and for allowing access to the shelves. In some embodiments, the basket frame 120 may further include front panel 123A and front panel 123B attached to a front end of the first side wall 124 and a front end of the second side wall 126 respectively. In some embodiments, the first side wall 124 and the second side wall 126 may wrap around the bottom wall 122 to form the front panels 123A, 123B.

The basket frame 120 defines four edges 127 that each extend downwardly beyond the bottom wall 122 to form legs 140 configured to allow the tiered basket 100 to be supported on a surface (e.g., to facilitate loading and unloading of food items, to facilitate storing the tiered basket 100, and/or the like). In some embodiments, each of the first side wall 124 and the second side wall 126 may include a side bracket 129 mounted thereto. In some embodiments, the side brackets 129 may function to facilitate placement of the tiered basket 100 into a cooking medium and/or facilitate removal of the tiered basket 100 from the cooking medium by way of an automatic or manual lifting mechanism (not shown). An example of such a lifting mechanism is provided in U.S. patent application Ser. No. 63/481,959 entitled A System for Assisting with Loading and Unloading Objects filed Jan. 27, 2023, the entire contents of which are incorporated herein by reference.

In one or more embodiments, the first side wall 124 and the second side wall 126 each define a plurality of coupling slots 172A-D and 174A-D respectively. As shown in FIG. 3A, the coupling slots 172A-D and 174A-D are preferably towards the back end of the first side wall 124 and the second side wall 126. In some embodiments, the first side wall 124 and the second side wall 126 each include projecting members 168A-D and 169A-D respectively that extend outwardly from the respective inner sides of the first side wall 124 and the second side wall 126. The coupling slots 172A-D, 174A-D in conjunction with the projecting members 168A-D, 169A-D may be configured for receiving the lower shelves 130A-C and the top shelf 130D. The projecting members 168A-D and 169A-D may function at least in part to support the lower shelves 130A-C and the top shelf 130D when the shelves are in a substantially horizontal position. In some embodiments, the projecting members 168A-D, 169A-D may be formed from stainless steel material, aluminum material, titanium material, cast iron, nickel-plated carbon steel, or other suitable materials. In some other embodiments, the first and second side walls 124, 126 may not include projecting members. For example, in some embodiments, the tiered basket 100 may include other support mechanisms for providing support for the lower shelves 130A-C and the top shelf 130D when in a substantially horizontal position. In one embodiment, as shown in FIG. 3B, each of the lower shelves 130A-C and the top shelf 130D may include a pair of legs 139 configured to support the respective shelf. The legs for each shelf may be positioned on a front end of the respective shelf and may extend downwardly from a bottom portion of the front end. In some embodiments, the legs are configured to function as a cam mechanism, whereby the leg of a shelf causes the shelf to slide backwards in the corresponding coupling slot when pivoting the shelf from a substantially vertical position to a substantially horizontal position. For example, in some embodiments, the legs of a shelf may be dimensioned to come in contact with the front panels 123A, 123B as the shelf is being pivoted from a substantially vertical position to a substantially horizontal position, causing the shelf to slide backwards in the corresponding slot (See FIG. 3B).

In one or more embodiments, the first side wall 124 and/or the second side wall 126 may define one or more openings that may function at least in part to allow the flow of cooking oil. As noted above, in one or more embodiments, the basket frame 120 may be formed from a thermal tolerant material. In some embodiments, the basket frame 120 may be formed from cast iron, nickel-plated carbon steel, and/or other suitable materials. In some embodiments, the basket frame 120 may be formed from a corrosion resistant food grade material (e.g., stainless steel, aluminum, titanium, or the like).

### B. Lower Shelves 130A-C

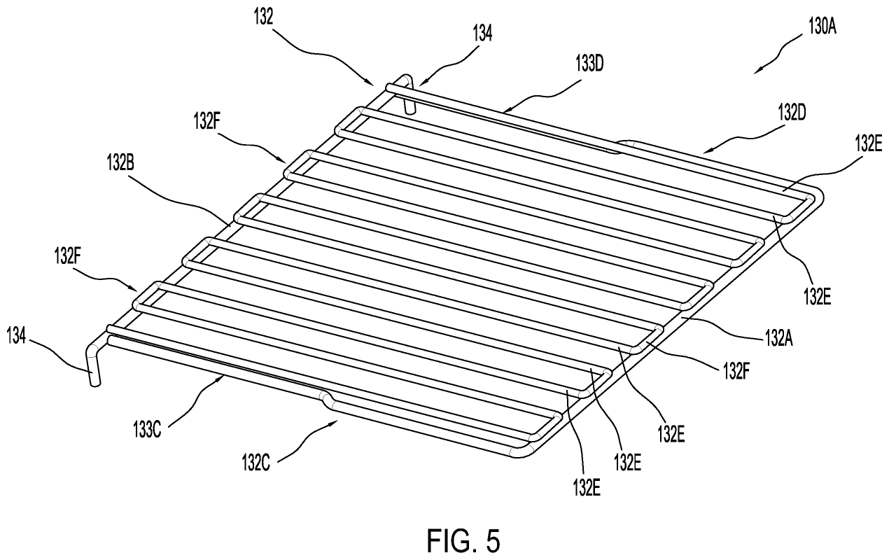

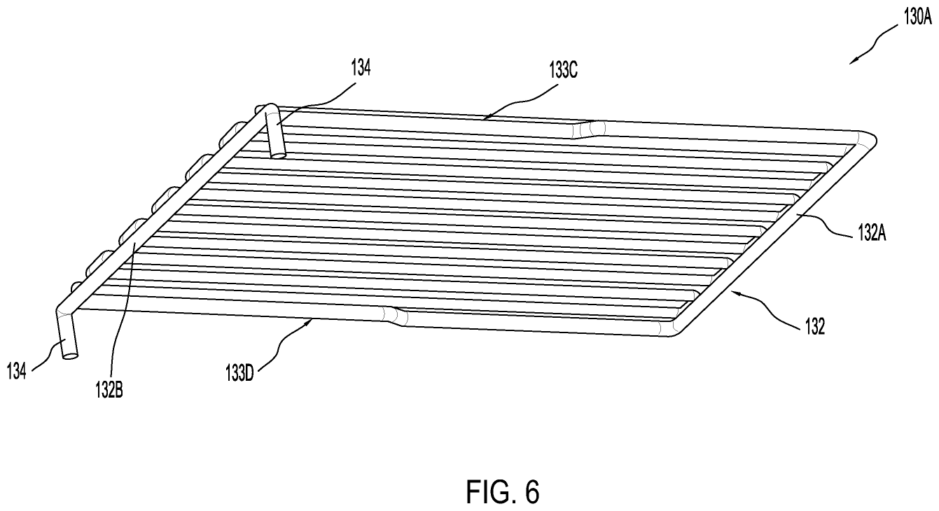

As noted above, the lower shelves 130A-C are configured for supporting or otherwise holding food items. In one or more embodiments, the lower shelves 130A-C may be formed from or otherwise comprise wire frame, sheet metal, metal mesh, the like, or combinations thereof. In some embodiments, the lower shelves 130A-C may be formed using one or more of a variety of techniques (e.g., laser cutting, embossing, stamping, 3D printing, computer numerical control (CNC) machining, casting, the like, or combinations thereof). Referring now to FIGS. 5 and 6 depicting one of the lower shelves 130A-C, the lower shelves 130A-C each include a lower shelf frame 132 having opposing front rod member 132A and rear rod member 132B and opposing first side rod member 132C and second side rod member 132D. In some embodiments, a plurality of individually spaced apart longitudinal wire/rod members may be attached to the opposing front and rear rod members 132A, 132B for supporting food items placed thereon. In preferred embodiments, as shown in FIGS. 5 and 6, a continuous wire/rod member formed into a plurality of spaced apart longitudinal members 132E and transverse end members 132F therebetween is attached to the lower shelf frame 132 (referred to herein as the tines of the lower shelves) to form a grill-like structure that is sufficiently dense to hold food items, such as chicken fillets, thereon.

The lower shelf frame 132 and/or the continuous wire/rod member of the lower shelves 130A-C may be formed from a thermally tolerant material. In some embodiments, the lower shelf frame 132 and/or the continuous wire/rod member of the lower shelves 130A-C may be formed from cast iron, nickel-plated carbon steel, and/or other suitable materials. In some embodiments the lower shelf frame 132 and/or the continuous wire/rod member of the lower shelves 130A-C may be formed from a corrosion resistant food grade material (e.g., stainless steel, aluminum, titanium, or the like). Accordingly the tines (e.g., plurality of spaced apart longitudinal members 132E and plurality of transverse end members 132F of the lower shelves 130A-C) may be formed from stainless steel material, aluminum material, titanium material, cast iron, nickel-plated carbon steel, or other suitable materials. Although illustrated with three lower shelves, more or fewer shelves could be used, such as five lower shelves.

As shown in FIGS. 5-6, each of the plurality of transverse end members 132F is attached (e.g., welded) to the opposing front and rear rod members 132A, 132B, thus creating a larger attachment/weld surface area—as compared to individually attached/welded discrete longitudinal wire/rod members—which in turn, reduces the likelihood of breakage. In other words, forming the longitudinal wire/rod members (e.g., tines) of the lower shelves 130A-C as a continuous patterned structure (e.g., repeated “U” shape) reduces the likelihood of the shelves coming apart (e.g., the longitudinal wire/rod members coming apart from the lower shelf frame). In one or more embodiments, each of the opposing first and second side rod members 132C, 132D includes an indented portion 133C, 133D respectively that functions to allow the shelves 130A-C to be moved laterally within the basket frame 120 (e.g., when in a substantially vertical position). In such embodiments, the indented portions 133C, 133D may be dimensioned such that they extend beyond the first side wall 124 and the second side wall 126 of the basket frame 120, when in a substantially vertical position (as shown in FIG. 2).

It should be noted that the indented portions 133C, 133D may be optimized (e.g., configured differently) for each of the lower shelves 130A-C. For example, in some embodiments, the indented portions 133C, 133D of one or more (e.g., all) of the lower shelves 130A-C may have a different configuration (e.g., height, length, depth, and/or the like) relative to one or more other lower shelves. In some embodiments, the indented portions 133C, 133D of each lower shelf may comprise the same configuration (e.g., height, length, depth, and/or the like) relative to the other lower shelves.

The lower shelves 130A-C are positioned within the basket frame 120 with the rear rod member 132B proximate to the inner side of the rear wall 128 of the basket frame 120, and each of the lower shelves 130A-C are positioned at different heights relative to the other shelves, such that they are spaced apart (e.g., stacked with one lower shelf on top of another with space between each pair of shelves). In one or more embodiments, the rear rod member 132B of the lower shelves 130A-C extends beyond each of the first and second side rod members 132C, 132D and projects downwardly at a terminal point to form coupling hooks 134 on opposing ends configured to at least in part secure the shelves 130A-C within the basket frame 120 of the tiered basket 100. While illustrated herein as an extension, the coupling hooks 134 may comprise an attachment (e.g., spherical attachments, plates, and/or the like). Furthermore, while illustrated herein as a rod, the coupling hooks 134 may be a different shape (e.g., spherical, rectangular, or the like). In some embodiments, the coupling hooks 134 of a lower shelf are configured to have substantially the same dimensions (e.g., the same lengths and/or the same widths/diameters). In some embodiments, the coupling hooks 134 of a lower shelf are configured to have different dimensions (e.g., different lengths and/or different widths/diameters).

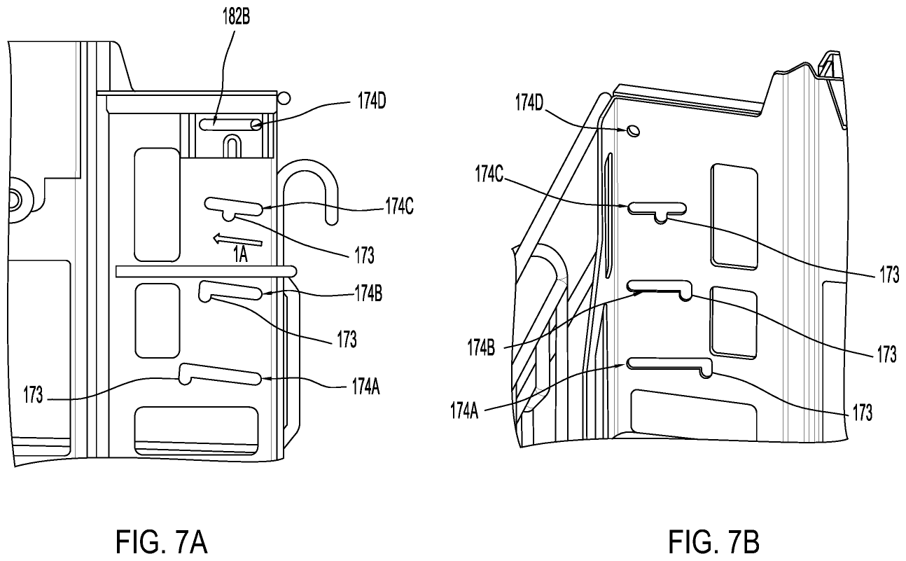

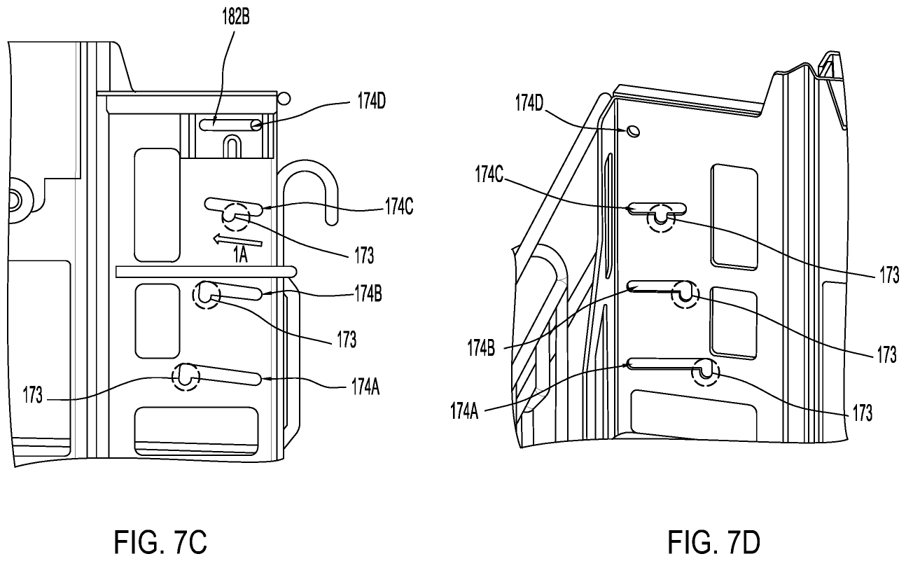

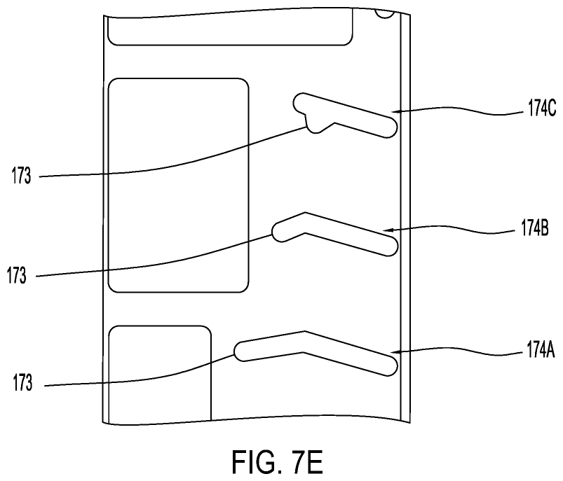

Referring to FIGS. 7A-D and referring back to FIGS. 1-4, in one or more embodiments, the projecting members 168A-D, 169A-D of the first and second side walls 124, 126 of the basket frame 120 may define a set of horizontally aligned projecting members. For example, projecting members 168A and 169A may be horizontally aligned, projecting members 168B and 169B may be horizontally aligned, projecting members 168C and 169C may be horizontally aligned, and projecting members 168D and 169D may be horizontally aligned. Similarly, coupling slots 172A-D of the first side wall 124 of the basket frame 120 and coupling slots 174A-D of the second side wall 126 of the basket frame 120 may define a set of horizontally aligned coupling slots. For example, in one or more embodiments, coupling slots 172A and 174A may be horizontally aligned, coupling slots 172B and 174B may be horizontally aligned, coupling slots 172C and 174C may be horizontally aligned, and coupling slots 172D and 174D may be horizontally aligned.

Each of the lower shelves 130A-C may correspond to one of the sets of horizontally aligned projecting members and one of the sets of horizontally aligned coupling slots. For example, as shown in FIG. 1, the front rod member 132A of the lower shelves are supported by corresponding projecting members 168A-C and 169A-C and the coupling hooks 134 extends through the corresponding coupling slots 172A-C, 174A-C to support the rear rod member 132B of the lower shelves 130A-C, thus supporting the lower shelves 130A-C within the basket frame 120. Furthermore, as shown in FIGS. 2 and 4, each set of horizontally aligned coupling slots may be positioned at a different height relative to the other sets of horizontally aligned coupling slots. Similarly, each set of horizontally aligned projecting members may be positioned at a different height relative to the other sets of horizontally aligned projecting members. Accordingly, the above configuration allows the shelves to be spaced apart within the basket frame 120 and to maintain a fixed height with respect to each shelf. In some embodiments, in addition to the projecting members or alternatively, each of the lower shelves 130A-C and top shelf 130D may include legs/feet extending from (or otherwise disposed) on the bottom portion of each shelf (e.g., bottom four corners) configured for maintaining a fixed height with respect to each shelf when in a substantially horizontal position. In such embodiments, the legs/feet (e.g., wire frame legs/feet) for each shelf may be supported by the shelf directly below when in a substantially horizontal position. In one embodiment and as depicted in FIGS. 3B and 3C, each of the lower shelves 130A-C and the top shelf 130D includes one or more legs/feet 139 configured for supporting the corresponding shelf when in a substantially horizontal position. For example, as depicted in FIG. 3C, each of the lower shelves 130A-C and the top shelf 130D includes two legs 139, with each leg 139 positioned on opposing ends of the respective shelf. In some other embodiments, each of the lower shelves 130A-C and the top shelf 130D may include less than two legs or more than two legs. In some embodiments, one or more of the shelves (e.g., lower shelves 130A-C, top shelf 130D) may include a plurality of legs distributed across a bottom portion of the respective shelf. In some embodiments, one or more of the shelves may include a single leg extending downwardly from the shelf. For example, in some embodiments, one or more shelves may include a single leg positioned substantially centrally with respect to the width of the shelf. Additionally or alternatively, the width of the single leg may be selected to ensure the leg provides sufficient support for the shelf when in substantially horizontal position.

Moreover, in one or more embodiments, each of the coupling slots 172A-C, 174A-C is substantially horizontal and has a length that is larger than or equal to the length of the coupling hook 134 of the corresponding shelf. Additionally, each of the coupling slots 172A-C, 174A-C has a height that is larger than or equal to the width/diameter of the coupling hooks 134 of the corresponding shelf but smaller than the length of the coupling hooks 134. As a result of the above-configuration, the coupling hooks 134 may function to secure the shelves 130A-C in place. As shown in FIG. 1, in the horizontal position (e.g., cooking position), for each lower shelf 130A-C, each of the coupling hooks 134 on the opposing ends of the rear rod member 132B extends through the corresponding coupling slots of the first side wall 124 and the second side wall 126. Moreover, the coupling hooks 134 extend downwards (e.g., perpendicularly downwards) relative to the corresponding coupling slot, thus preventing the coupling hooks 134 from sliding out of the substantially horizontal coupling slots, and thus securing the shelves 130A-C in place. The above-configuration may facilitate removal and/or assembly of a shelf in either left to right direction or right to left direction (as further described below).

In some embodiments, one or more coupling slots has a length that is smaller than the length of the coupling hook 134 of the corresponding shelf. For example, each coupling slot of one of the sets of coupling slots (e.g., set of coupling slots 172A-C or set of coupling slots 174A-C) may have a length that is smaller than the length of the coupling hook 134 of the corresponding shelf or a height that is smaller than the width/diameter of the coupling hook 134 of the corresponding shelf, while each coupling slot of the other set of coupling slots (e.g., set of coupling slots 172A-C or set of coupling slots 174A-C) may have a length that is larger than the length of the coupling hook 134 of the corresponding shelf or a height that is larger the width/diameter of the corresponding shelf. As such, the above example configuration may facilitate removal and/or assembly of a shelf in only one direction (as further described below).

Furthermore, as a result of the above-configuration, each of the lower shelves 130A-C may be pivoted upwardly from a substantially horizontal position to a substantially vertical position, and vice versa. As shown in FIG. 2, when the lower shelves are pivoted to a substantially vertical position, the coupling hooks 134, in turn, pivot from a perpendicular/vertical position to a substantially horizontal position.

In various embodiments, in order to pivot a particular lower shelf from a substantially horizontal position to a substantially vertical position, each shelf above the particular lower shelf must first be pivoted substantially vertically. As a result, as shown in FIGS. 2 and 7A-D, to clear the space occupied by the substantially vertically positioned shelves above, the coupling hooks 134 of the lower shelf below are caused to slide forward (in the direction indicated by arrow “lA”) within the coupling slots when the lower shelf is pivoted upwards. Furthermore, as shown in FIG. 7A, in some embodiments, the length of each of the coupling slots 172A-C and 174A-C may be different and dimensioned based at least in part on the number of shelves configured to be positioned above the coupling slot. For example, in some embodiments, as shown in FIGS. 7A-D, the lower the coupling slot, the longer the length (given that there are more shelves to clear). In some embodiments, each of the coupling slots 172A-C and 174A-C may be configured to have the same length based at least in part on a length that is suitable for the lowest shelf of the lower shelves 130A-C.

In some embodiments, to ensure the coupling hooks 134 are held in place while in the substantially vertical position (e.g., while loading food items thereon) and/or to ensure the coupling hooks 134 do not slide out of the coupling slots 172A-C, 174A-C when in the substantially vertical position, each of the coupling slots 172A-C and 174A-C may include a depressed portion 173 (as shown in FIGS. 7A-D) configured to receive the corresponding coupling hooks 134 (as shown in FIG. 2) and hold in place. For example, the depressed portion 173 may be configured to receive the horizontal portion of a coupling hook 134 of a shelf when the shelf is in a substantially vertical position. As illustrated in FIG. 7C-D, for each coupling slot, the depressed portion 173 may be positioned at different lengths/distances with respect to the rear wall 128 based at least in part on the position of the corresponding coupling slot relative to other coupling slots (e.g., based at least in part on the number of shelves configured to be positioned above the coupling slot). For example, in some embodiments, the lower the coupling slot, the further away the depressed portion 173 is relative to the rear wall 128. As noted above, in some embodiments, each of the coupling slots 172A-C and 174A-C may be configured to have the same length. In such embodiments, the depressed portions 173 of the coupling slots 172A-C and 174A-C are positioned at different lengths. Furthermore, in some embodiments, each of the coupling slots 172A-C and 174A-C may include one or more additional depressed portions (not shown) configured for holding the shelves at different positions.

In various embodiments, for a particular lower shelf (e.g., 130A-C), the shelves above it prevents the particular lower shelf from coming out of place. In some embodiments, the coupling slots 172A-C, 174A-C may be inclined (e.g., orientated at an angle) to further ensure the shelves 130A-C are secured in the vertical orientation and/or to facilitate removal of the shelves 130A-C. For example, in some embodiments, one or more of the coupling slots 172A-C, 174A-C is orientated at an angle relative to a horizontal plane. In some embodiments and as depicted in FIG. 7C, for each of one or more coupling slots, the depressed portion 173 and a rear end of the slot (e.g., the end proximate to the rear wall of the basket frame) are on a substantially horizontal plane relative to each other. For example, the depressed portion 173 may be positioned at a height that is substantially the same as height with respect to which the rear end is positioned. In some embodiments, for each of one or more coupling slots, the depressed portion and the rear end of the coupling slots are positioned at different heights relative to each other. For example, in some embodiments (as depicted in FIG. 7B), a particular slot may be positioned lower relative to the rear end of the slot, and in some other embodiments (as depicted in FIG. 7E), a particular slot may be positioned higher relative to the rear end of the slot. The depressed portion 173 of a given slot may be configured to have a desired depth. In some embodiments, each of the coupling slots 172A-C, 174A-C have the same depth relative to the other coupling slots. In some embodiments, and as depicted in FIG. 7E, one or more of the coupling slots 172A-C, 174A-C may have different depths. Additionally or alternatively, as shown in FIG. 7E, a coupling slot and/or a depressed portion thereof may be orientated at an angle, such that the depressed portion 173 is positioned at a height that is higher relative to the rear end of the slot. Having the depressed portion of a slot positioned higher than the rear end of the slot gives more room to the lower shelf directly below when loading the tiered basket 100. As such, making the loading process easier. In some embodiments, a depressed portion 173 may define an angle relative to a vertical plane. In some embodiments, the tiered basket 100 may include one or more hinges (not shown) disposed transverse to the basket frame 120 to further facilitate pivoting and/or securing of the shelves in a substantially vertical position.

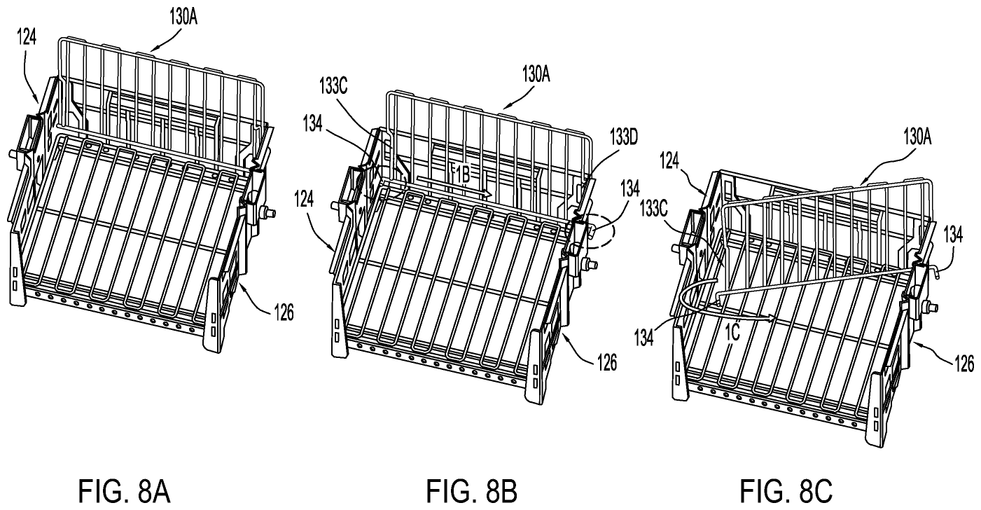

Moreover, as a result of the above-configuration, each of the lower shelves 130A-C are removable and replaceable. In one or more embodiments, the lower shelves 130A-C may be replaced without requiring tools. To remove a lower shelf (e.g., 130A), the lower shelf is first pivoted to a substantially vertical position as shown in FIG. 8A. Pivoting a lower shelf to a substantially vertical position causes the coupling hooks 134 to also be pivoted to a substantially horizontal position, as described above, such that the coupling hooks may slide through the coupling slots. The lower shelf is then moved laterally from right to left (not shown) or left to right (as shown in FIG. 8B), such that one of the coupling hooks 134 slides through the corresponding coupling slot (e.g., is disengaged from the side wall defining the corresponding coupling slot).

For example, if the lower shelf is moved laterally to the right as shown in FIG. 8B, the coupling hook 134 attached to the first side wall 124 slides through the coupling slot of the first side wall 124. Similarly, if the lower shelf is moved laterally to the left (not shown), the coupling hook attached to the second side wall 126 slides through the coupling slot of the second side wall 126. As noted above, each of the opposing first and second sides 132C, 132D of the lower shelves 130A-C include an indented portion 133C, 133D that allows the shelves 130A-C to be moved laterally when in a substantially vertical position. In the illustration of FIG. 8B, the lower shelf is moved laterally in the direction indicated by the arrow “1B,” causing the coupling hook 134 of the first side wall 124 to slide through the coupling slot. Subsequent to moving the lower shelf laterally and sliding one of the coupling hooks 134 through the corresponding coupling slot, the lower shelf may be rotated in the direction indicated by “1C,” as shown in FIG. 8C, to slide the second coupling hook through the corresponding coupling slot (e.g., disengage from the corresponding side wall). Having disengaged the lower shelf from the basket frame 120, the lower shelf may then be lifted out of the basket frame 120 or otherwise removed from the basket frame 120.

### B. Top Shelf

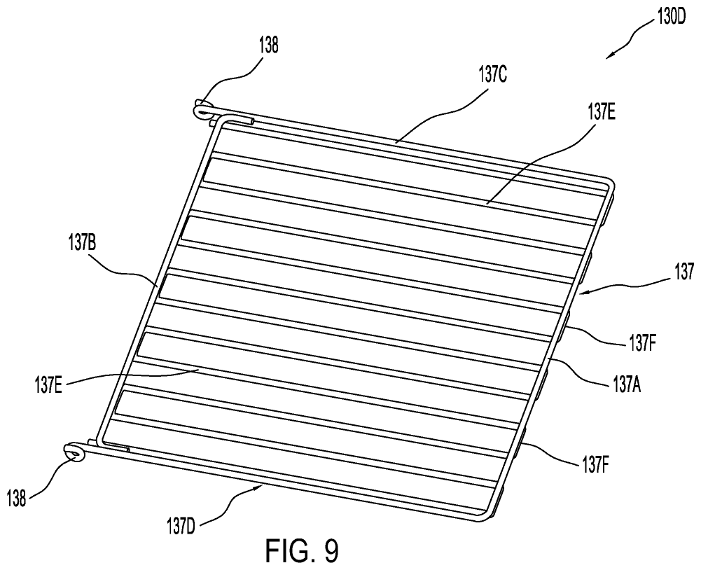

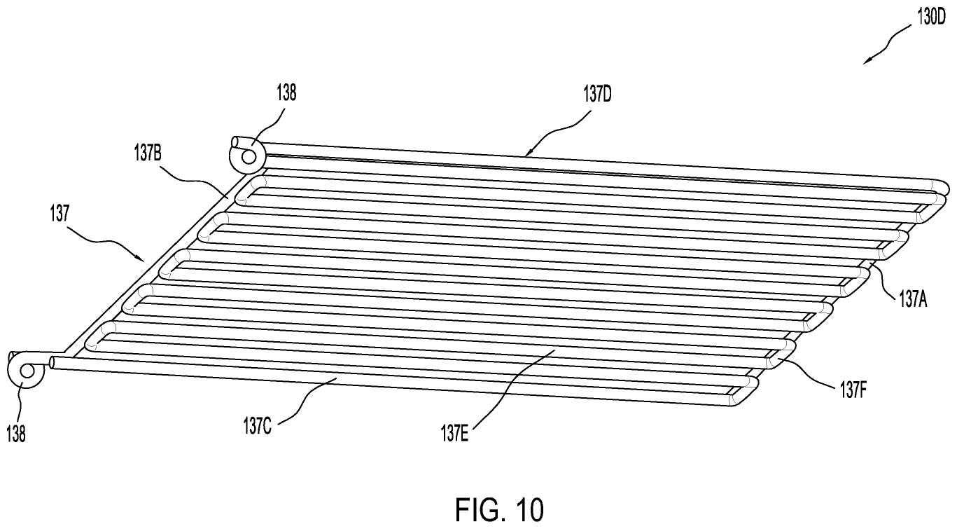

As noted above, the top shelf 130D may or may not support food items. In one or more embodiments, the top shelf 130D may be formed from or otherwise comprise wire frame, sheet metal, metal mesh, the like, or combinations thereof. In some embodiments, the top shelf 130D may be formed using one or more of a variety of techniques (e.g., laser cutting, embossing, stamping, 3D printing, computer numerical control (CNC) machining, casting, the like, or combinations thereof). Referring to FIGS. 9-10, the top shelf 130D includes a top shelf frame 137 having opposing front rod member 137A and rear rod member 137B and opposing first side rod member 137C and second side rod member 137D. Similar to the lower shelves 130A-C, in some embodiments, as shown in FIGS. 9-10, a continuous wire/rod member formed into a plurality of spaced apart longitudinal members 137E and transverse end members 137F therebetween is attached to the top shelf frame 137 (referred to herein as the tines of the top shelf). The continuous wire/rod member of the top shelf 130D may be formed from thermally tolerant material. In some embodiments, the top shelf frame 137 and the continuous wire/rod member of the top shelf 130D may be formed from cast iron, nickel-plated carbon steel, and/or other suitable materials. In some embodiments, the top shelf frame 137 and the continuous wire/rod member of the top shelf 130D may be formed from a corrosion resistant food grade material (e.g., stainless steel, aluminum, titanium, or the like). Accordingly the tines (e.g., plurality of spaced apart longitudinal members 137E and plurality of transverse end members 137F) of the top shelf 130D may be formed from stainless steel material, aluminum material, titanium material, cast iron, nickel-plated carbon steel, or other suitable materials. As shown in FIGS. 9-10, each of the plurality of transverse end members 132F is attached (e.g., welded) to the opposing front and rear rod members 137A, 137B, thus creating a larger attachment/weld surface area—as compared to individually attached discrete longitudinal members.

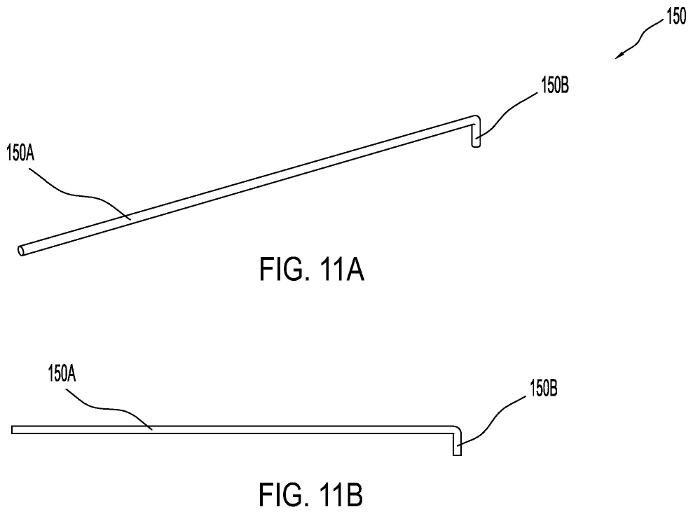

As shown in FIGS. 9 and 10, in some embodiments, each of the first and second side members 137C, 137D extends beyond the rear rod member 137B to form skewer loops 138. As shown in FIG. 10, in some embodiments, the rear rod member 137b may include one or more skewer loops 138 or otherwise one or more skewer loops may be formed on the rod member 137B. The skewer loops 138 are configured for receiving a skewer member 150 depicted in FIGS. 11A-B. As shown in FIGS. 11A-B, the skewer member 150 includes an elongated first skewer portion 150A and a second skewer portion 150B extending substantially perpendicularly from the elongated first skewer portion 150A. The skewer member 150 extends through each of coupling slot 172D, the skewer loops 138, and coupling slot 174D to pivotally secure, in conjunction with a locking bracket 180 (skewer locking mechanism), the rear rod member 137B of the top shelf 130D within the basket frame 120. The above-configuration allows the top shelf 130D to be pivoted about the skewer member 150 from a substantially horizontal position to a substantially vertical position and vice versa.

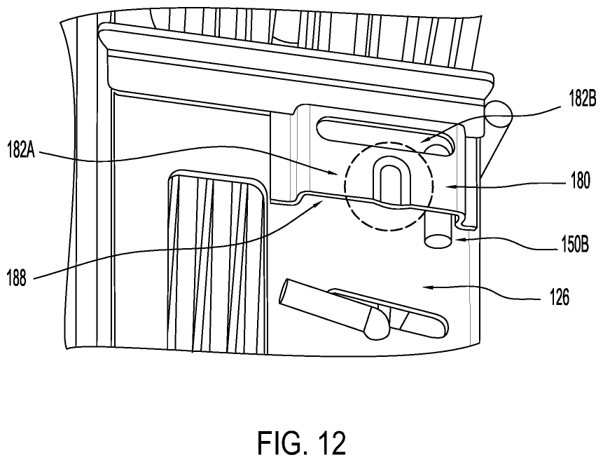

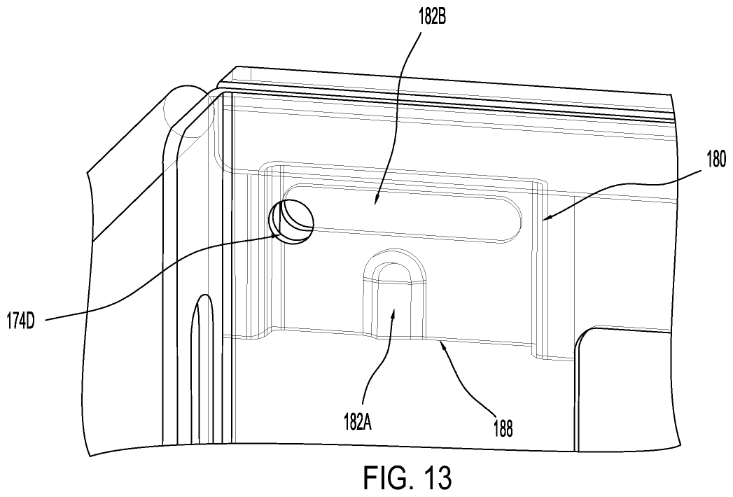

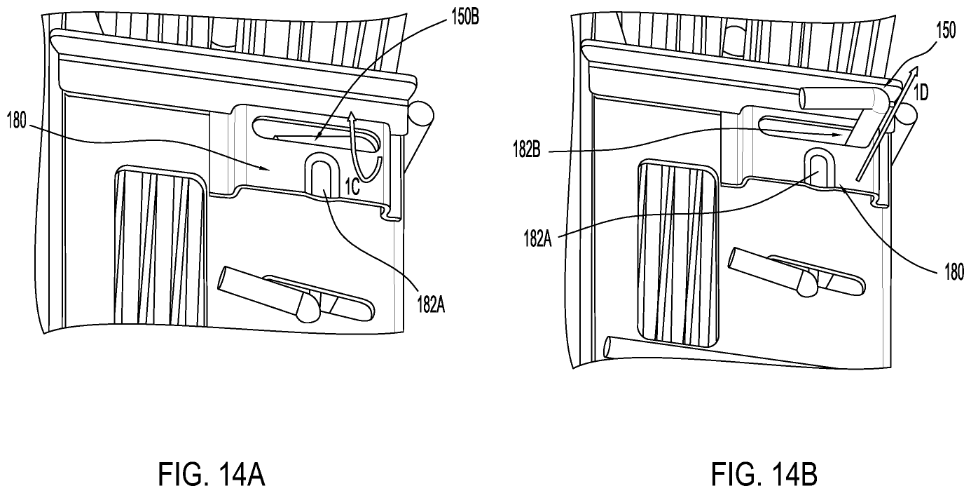

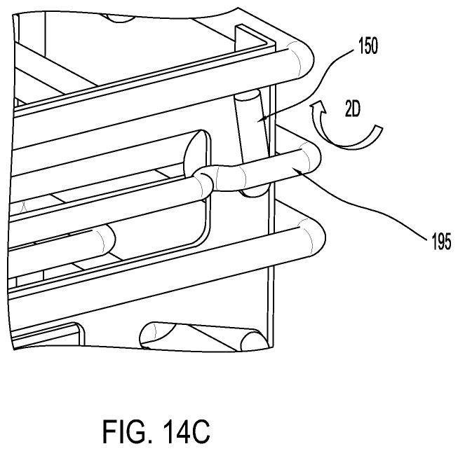

As shown in FIG. 12, in some embodiments, the locking bracket 180 is mounted on the second side wall 126. It should be noted that in some embodiments, the locking bracket 180 may be mounted on the first side wall 124. The second side wall 126 and the locking bracket 180 define a cavity 188 for locking the second skewer portion 150B therein. As shown in FIGS. 12-13, the locking bracket 180 defines a locking slot 182B for receiving the second skewer portion 150B therethrough such that the second skewer portion 150B is positioned within the cavity 188 perpendicular to the locking slot 182B. In one or more embodiments, the locking bracket 180 includes a depressed portion 182A that functions as a friction lock to prevent the second skewer portion 150B from sliding out of the cavity 188 and/or the locking slot 182B. Similar, to the lower shelves 130A-C, the top shelf 130D may be removed and/or replaced. Referring to FIG. 14A-B, to remove the top shelf 130D, the skewer member 150 is rotated in the direction indicated by the arrow “1C,” as shown in FIG. 14A, to cause the second skewer portion 150B to be orientated substantially horizontally aligned with the locking slot 182B. The skewer member 150 may then be moved in the direction indicated by the arrow “1D,” as shown in FIG. 14B to disengage/remove the skewer member 150 from the top shelf 130D.

While in the illustrated embodiment of FIG. 12, the skewer locking mechanism comprises or otherwise embodies a locking bracket, in other embodiments, the skewer member may be secured using other locking mechanisms. As shown in FIG. 14C, in some embodiments, the locking mechanism may comprise a locking bar (e.g., bent wire) 195 formed into a shape configured to secure the skewer member 150 between the locking bar and an exterior side of the first side wall 124 or exterior side of the second side wall 126. The skewer member 150 extends through each of coupling slot 172D, the skewer loops 138, and coupling slot 174D to pivotally secure, in conjunction with the locking bar 195 (skewer locking mechanism), the rear rod member 137B of the top shelf 130D within the basket frame 120. Thus, allowing the top shelf 130D to be pivoted about the skewer member 150 from a substantially horizontal position to a substantially vertical position and vice versa. To remove the top shelf 130D, the skewer member 150 is rotated (clockwise or counterclockwise) as shown in FIG. 14C, to disengage the second skewer portion 150B from the locking bar 195. The skewer member 150 may then be moved in the direction indicated by the arrow “2D,” as shown in FIG. 14B to remove the skewer member 150 from the top shelf 130D.

### C. Replacement Scheme

Repeated heating and cooling of the tiered basket 100, shaking the tiered basket 100 to remove food items, dropping the tiered basket 100 on the floor, and the like, may cause the tiered basket 100 to break. For example, the tines of the top shelf, tines of the lower shelves, or tines of the bottom shelf may break due to one or more of the above reasons or other reasons. Accordingly, the tiered basket 100 is configured such that broken shelves can be removed and replaced without tools. To replace the top shelf 130D, the skewer member 150 is first removed from the top shelf 130D by rotating the skewer member 150 such that the second skewer portion 150B of the skewer member 150 is substantially parallel to the locking slot 182B and then sliding the skewer member 150 through the locking slot 182B to remove the skewer member 150 from the top shelf 130D. Having removed the skewer member 150 from the top shelf 130D, the top shelf 130D may then be removed by lifting out of the basket frame 120 or otherwise separated from the basket frame 120. The top shelf 130D may then be replaced by inserting the skewer member 150 through the locking slot 182B, the coupling slots 172D and 174D, and the skewer loops 138 of the replacement shelf.

To replace a broken lower shelf each shelf above the broken lower shelf must first be removed. Accordingly, in various embodiments, the process of replacing a broken lower shelf may begin by first removing the top shelf 130D as described above. Having removed the top shelf 130D, each of the lower shelves above the broken lower shelf may then be removed sequentially starting from the uppermost lower shelf (e.g., lower shelf directly below the top shelf 130D). To remove each lower shelf, as described above, the lower shelf is first pivoted to a substantially vertical position and then moved laterally from left to right or from right to left to disengage one of the coupling hooks 134 from the corresponding side wall. For example, if the lower shelf is moved laterally to the right as shown in FIG. 8B, the coupling hook 134 attached to the first side wall 124 (e.g., positioned on an exterior side of the first side wall 124) slides through the coupling slot of the first side wall 124. Similarly, if the lower shelf is moved laterally to the left (not shown), the coupling hook attached to the second side wall 126 (e.g., positioned on an exterior side of the second side wall 126) slides through the coupling slot of the second side wall 126.

Having disengaged one of the coupling hooks from the corresponding side wall, the shelf is rotated to remove the second opposing coupling hook 134 of the lower shelf from the other side wall. The lower shelf may then be removed by lifting the shelf out of the basket frame 120 or otherwise separating the lower shelf from the basket frame 120. Each lower shelf is sequentially removed in this manner until the broken lower shelf is removed. The broken lower shelf may then be replaced with a replacement shelf and all the removed shelves (e.g., removed lower shelves and top shelf) re-assembled in the reverse order in which they were removed. The replacement shelf, the removed lower shelves, and the top shelf may be replaced as described throughout this disclosure.

While, as described above, in some embodiments, a lower shelf can be removed at least in part by moving the lower shelf laterally in either direction (e.g., right to left or left to right), in some embodiments, a lower shelf may be configured such that it can be removed in only one direction. For example, in some embodiments, one of the sets of the coupling slots (e.g., set of coupling slots 172A-C or set of coupling slots 174A-C) and the coupling hooks 134 of the corresponding shelves may be dimensioned such that the coupling hooks 134 may not fit through the coupling slots, while the other set of the coupling slots (e.g., set of coupling slots 172A-C or set of coupling slots 174A-C) and coupling hooks 134 of the corresponding shelves may be dimensioned such that the coupling hooks 134 can fit through the coupling slots.

In one or more embodiments, the bottom shelf 190 may be removable and/or replaceable. In such embodiments, a bottom shelf (e.g., broken bottom shelf) may be replaced by first removing all the lower shelves 130A-C and the top shelf 130D (e.g., above the bottom shelf 190) as described above, and then lifting the bottom shelf 190 out of the basket frame 120 or otherwise separating the bottom shelf 190 from the basket frame 120. Accordingly, no tools, welder, or the like is required to replace the shelves (top shelf, lower shelves, and/or bottom shelf). Indeed, the shelves may be replaced at the establishment (e.g. restaurant) where the tiered basket 100 is being utilized. For example, broken shelves of the tiered basket 100 may be replaced by a restaurant employee. In some embodiments, the attachment mechanism for the top shelf 130D (e.g., skewer/friction lock), as described above, may be applied not only to the top shelf 130D but also to the lower shelves 130A-C and/or the bottom shelf 190. In other words, in some embodiments, the lower shelves 130A-C and/or the bottom shelf 190 may be removably attached to the frame basket 120 using the same attachment mechanism as the top shelf. In such embodiments, each shelf may be removed and replaced in the manner the top shelf is removed and replaced (as described above). Thus in such embodiments, each shelf of the tiered basket 100 may be removed and replaced independently without removing the shelves above.

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A basket for holding food products in a cooking apparatus, comprising:
a frame comprising opposing first side wall and second side wall defining a space therebetween, the first side wall defining a first set of coupling slots and the second side wall defining a second set of coupling slots; and
a plurality of shelves, the plurality of shelves vertically stackable between the first side wall and the second side wall, and pivotable between a substantially horizontal position and a substantially vertical position,
wherein each shelf of the plurality of shelves comprises coupling members extending through corresponding slots of the first set of coupling slots and the second set of coupling slots to provide for removing each shelf from within the frame without tools.

2. The basket of claim 1, wherein the coupling members, the first set of coupling slots, and the second set of coupling slots are further configured to enable the plurality of shelves to pivot between the substantially horizontal position and the substantially vertical position.

3. The basket of claim 1, wherein the plurality of shelves are configured for being pivoted from the substantially horizontal position to the substantially vertical position in top to bottom sequential order.

4. The basket of claim 1, wherein the frame further comprises a bottom wall and a rear wall, each of the bottom wall and the rear wall attached to the first side wall and the second side wall.

5. The basket of claim 4, wherein the rear wall defines a rear hook configured for coupling the basket to a support structure.

6. The basket of claim 1, wherein the first set of coupling slots and the second set of coupling slots are horizontally aligned to provide for positioning the plurality of shelves in the substantially horizontal position.

7. The basket of claim 1, wherein one or more of the first set of coupling slots and the second set of coupling slots has a length configured to provide for moving a respective shelf forward when being pivoted from the substantially horizontal position to the substantially vertical position to allow the respective shelf to clear other shelves already being pivoted to their substantially vertical position.

8. The basket of claim 1, wherein the plurality of shelves comprise at least one lower shelf and a top shelf.

9. The basket of claim 8, wherein each of the plurality of shelves comprise:
opposing front rod member and rear rod member;
opposing first side rod member and second side rod member; and
a plurality of individual longitudinal members, the plurality of individual longitudinal members spaced apart and attached to the front rod member and the rear rod member.

10. The basket of claim 8, wherein each of the plurality of shelves comprise:
opposing front rod member and rear rod member;
opposing first side rod member and second side rod member; and
a continuous rod member formed into a plurality of spaced apart longitudinal members and transverse end members therebetween the longitudinal members, wherein the transverse end members are attached to the front rod member and the rear rod member.

11. The basket of claim 10, wherein each of the opposing first side rod member and second side rod member of the at least one lower shelf comprises an indented portion configured to provide for moving the at least one lower shelf laterally within the frame when in a substantially vertical position and enable removal of the at least one lower shelf without tools.

12. The basket of claim 10, wherein the coupling members of the top shelf comprises a first coupling loop extending from a first end of the first side rod member and a second coupling loop extending from a second end of the second end of the second side rod member, wherein the first coupling and the second coupling loop are configured for receiving a skewer member therethrough.

13. The basket of claim 12, further comprising a locking bracket mounted on at least one of the first side wall or the second side wall, the locking bracket defining a locking slot and configured for receiving the skewer member therethrough to provide for securing the top shelf within the frame of the basket.

14. The basket of claim 1, wherein the frame is formed from thermally tolerant material.

15. The basket of claim 1, wherein the first set of coupling slots are vertically separated from each other, and the second set of coupling slots are vertically separated from each other.

16. The basket of claim 1, wherein one or more of the first set of coupling slots and the second set of coupling slots comprise a depressed portion configured to receive at least a portion of the corresponding shelf when in the substantially vertical position.

17. A replaceable shelf for a basket, the shelf comprising:
opposing front rod member and rear rod member;
opposing first side rod member and second side rod member; and
a continuous rod member formed into a plurality of spaced apart longitudinal members and transverse end members therebetween the longitudinal members, wherein the transverse end members are attached to the front rod member and the rear rod member.

18. A method for replacing a lower shelf of a basket comprising a plurality of shelves, the method comprising:
pivoting the lower shelf to a substantially vertical position;
moving the lower shelf laterally to disengage the coupling members of the lower shelf from the frame of the basket; and
separating the lower shelf from the frame of the basket.

19. The method of claim 18, wherein the plurality of shelves of the basket are configured for being removed sequentially from top to bottom and begins with removing a skewer member securing a top shelf of the basket to the frame of the basket.

20. The method of claim 18, wherein each shelf above the lower shelf must be removed before the lower shelf can be removed.
